(19) United States
(12) Patent Application Publication
(10) Pub. No.: US 2026/0004760 A1
(43) Pub. Date: Jan. 1, 2026

(54) ELECTRONIC MUSICAL INSTRUMENT, MUSICAL SOUND OUTPUT METHOD, AND RECORDING MEDIUM

(71) Applicant: Roland Corporation, Shizuoka (JP)

(72) Inventor: Takashi Nishimura, Hamamatsu (JP)

(73) Assignee: Roland Corporation, Shizuoka (JP)

(21) Appl. No.: 19/216,645

(22) Filed: May 22, 2025

(30) Foreign Application Priority Data
Jun. 28, 2024 (JP) 2024-105357

(51) Int. Cl. G10H 1/26

(52) U.S. Cl. CPC G10H 1/26; G10H 2210/281; G10H 2220/221; G10H 2220/271

(57) ABSTRACT

Provided are an electronic musical instrument, a musical sound output method, and a musical sound output program capable of independently generating different musical sounds, that is, a normal musical sound and a special musical sound, through an operation on a single key. In a case where the position of a key becomes equal to or lower than a sound generation start position while the speed of the key is maintained higher than a speed threshold value, the normal musical sound of the key is generated while the special musical sound is not generated. In a case where the speed becomes equal to or lower than the speed threshold value before the position of the key reaches the sound generation start position, the special musical sound of the is generated while the normal musical sound is not generated.

### CROSS-REFERENCE TO RELATED APPLICATION

This application claims the priority benefit of Japanese application serial no. 2024-105357, filed on Jun. 28, 2024. The entirety of the above-mentioned patent application is hereby incorporated by reference herein and made a part of this specification.

### TECHNICAL FIELD

The disclosure relates to an electronic musical instrument, a musical sound output method, and a recording medium.

### BACKGROUND TECHNOLOGY

Patent Document 1 discloses a keyboard instrument that switches between two types of timbres (playing techniques) according to key depression depth (first range Q1, second range Q2). Specifically, in a case where the key depression depth is in the first range Q1, a first playing technique sound is generated, and in a case where the key depression depth is in the second range Q2 which is deeper than the first range Q1, a second playing technique sound is generated. This makes it possible to output musical sounds with multiple timbres through an operation of the user on a single key.

### RELATED ART DOCUMENTS

### Patent Documents

[Patent Document 1] Japanese Patent No. 7347536

However, according to Patent Document 1, in a case where the second playing technique sound is generated, the key depression depth changes from the first range Q1 to the second range Q2, so the first playing technique sound is generated prior to the generation of the second playing technique sound. This causes a problem that the user cannot generate only the second playing technique sound.

The disclosure provides an electronic musical instrument, a musical sound output method, and a musical sound output program capable of independently generating different musical sounds, a normal musical sound and a special musical sound, through an operation on a single key.

### SUMMARY

An electronic musical instrument according to an embodiment of the disclosure includes a keyboard having multiple keys, and includes: a normal musical sound generation part generating a normal musical sound in a case where, after the key is depressed, a position of the key reaches a sound generation start position; and a special musical sound generation part generating a special musical sound different from the normal musical sound in a case where, after the key is depressed, a speed of the key becomes equal to or lower than a speed threshold value before the position of the key reaches the sound generation start position.

Another electronic musical instrument according to an embodiment of the disclosure includes a keyboard having multiple keys, and includes: a normal musical sound generation part generating a normal musical sound in a case where, after the key is depressed, a position of the key reaches a sound generation start position; and a special musical sound generation part generating a special musical sound different from the normal musical sound in a case where, after the key is depressed, an acceleration of the key becomes equal to or lower than an acceleration threshold value before the position of the key reaches the sound generation start position.

A musical sound output method according to an embodiment of the disclosure is a method executed in an electronic musical instrument including a keyboard having multiple keys, and includes: a normal musical sound generation step of generating a normal musical sound in a case where, after the key is depressed, a position of the key reaches a sound generation start position; and a special musical sound generation step of generating a special musical sound different from the normal musical sound in a case where, after the key is depressed, a speed of the key becomes equal to or lower than a speed threshold value before the position of the key reaches the sound generation start position.

Another musical sound output method according to an embodiment of the disclosure is a method executed in an electronic musical instrument including a keyboard having multiple keys, and includes: a normal musical sound generation step of generating a normal musical sound in a case where, after the key is depressed, a position of the key reaches a sound generation start position; and a special musical sound generation step of generating a special musical sound different from the normal musical sound in a case where, after the key is depressed, an acceleration of the key becomes equal to or lower than an acceleration threshold value before the position of the key reaches the sound generation start position.

A non-transitory computer readable recording medium according to an embodiment of the disclosure stores a musical sound output program for causing a computer including a keyboard having multiple keys to execute musical sound output processing. The musical sound output program causes the computer to execute: a normal musical sound generation step of generating a normal musical sound in a case where, after the key is depressed, a position of the key reaches a sound generation start position; and a special musical sound generation step of generating a special musical sound different from the normal musical sound in a case where, after the key is depressed, a speed of the key becomes equal to or lower than a speed threshold value before the position of the key reaches the sound generation start position.

Another non-transitory computer readable recording medium according to an embodiment of the disclosure stores a musical sound output program for causing a computer including a keyboard having multiple keys to execute musical sound output processing. The musical sound output program causes the computer to execute: a normal musical sound generation step of generating a normal musical sound in a case where, after the key is depressed, a position of the key reaches a sound generation start position; and a special musical sound generation step of generating a special musical sound different from the normal musical sound in a case where, after the key is depressed, an acceleration of the key becomes equal to or lower than an acceleration threshold value before the position of the key reaches the sound generation start position.

### BRIEF DESCRIPTION OF THE DRAWINGS

FIG. 1 is a diagram showing the external appearance of a synthesizer.

FIG. 2A is a graph showing the transition of the position of a key in a case of generating a normal musical sound, and FIG. 2B is a graph showing the transition of the position of a key in a case of generating a special musical sound.

FIG. 3 is a functional block diagram of the synthesizer.

FIG. 4 is a block diagram showing the electrical configuration of the synthesizer.

FIG. 5A is a flowchart of main processing, and FIG. 5B is a flowchart of shallow key depression sound generation processing.

FIG. 6A is a flowchart of deep key depression sound generation processing, and FIG. 6B is a flowchart of muting processing.

### DESCRIPTION OF THE EMBODIMENTS

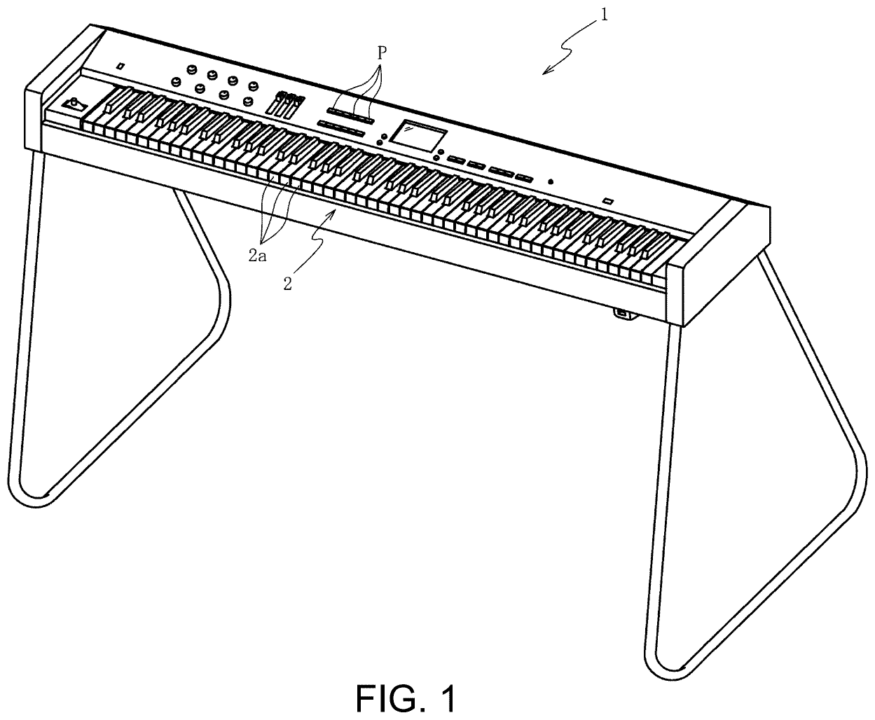

Hereinafter, exemplary embodiments will be described with reference to the attached figures. Referring to FIG. 1, the overview of a synthesizer 1 of this embodiment will be described. FIG. 1 is a diagram showing the external appearance of the synthesizer 1. The synthesizer 1 is an electronic musical instrument that outputs (releases sounds) by mixing a musical sound based on a performance operation of a user H and a predetermined accompaniment sound, etc. The synthesizer 1 can apply acoustic effects (effects) such as reverb, chorus, and delay by performing calculation processing on waveform data that mixes the musical sound from the performance of the user H and the accompaniment sound, etc.

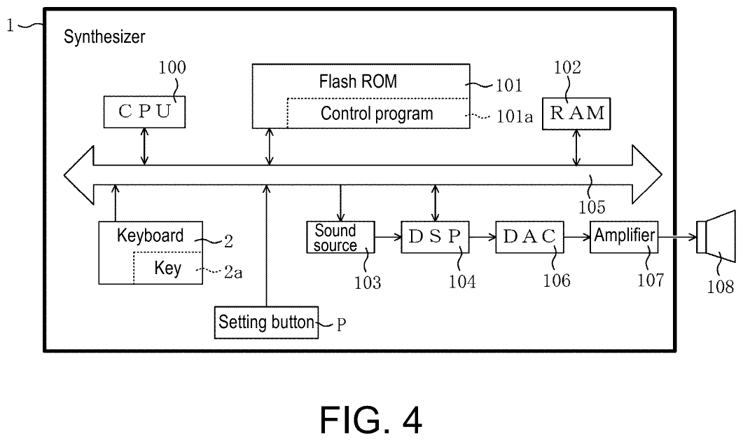

The synthesizer 1 mainly includes a keyboard 2 and setting buttons P where various settings are input from the user H. The keyboard 2 includes multiple keys 2a, and is an input device for acquiring performance information from the performance of the user H. Key depression information corresponding to a key depression/release operation (that is, performance operation) of the user H on the key 2a is output to a CPU 100 (see FIG. 4).

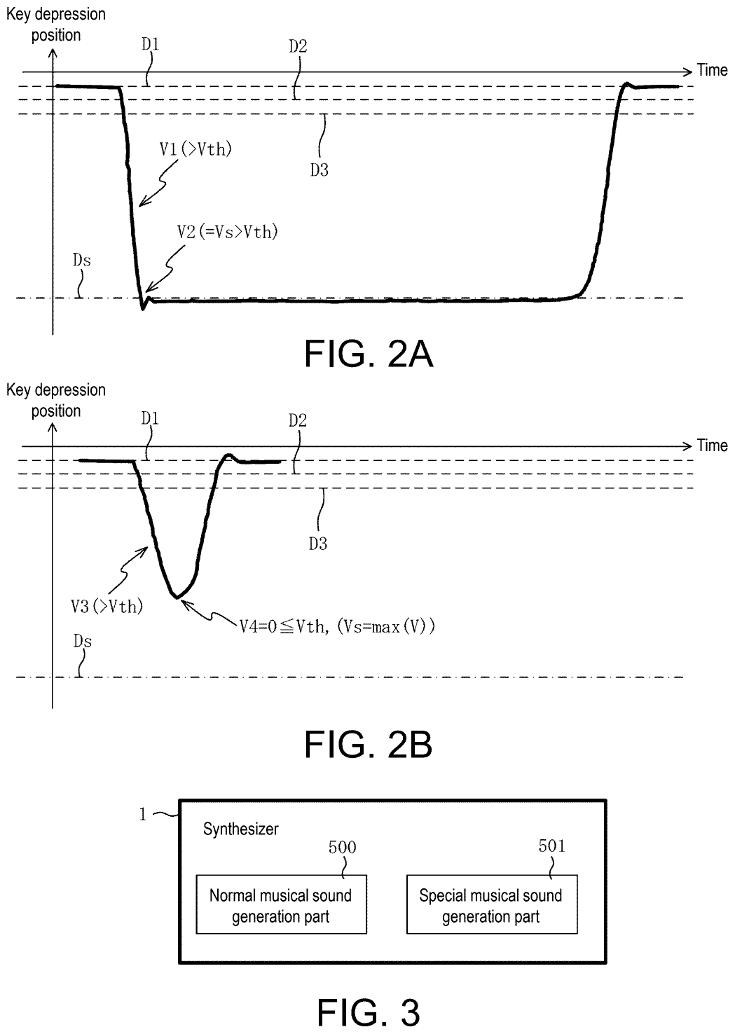

In this embodiment, according to the position of the key 2a in the vertical direction when the key 2a is depressed (hereinafter abbreviated as “position of the key 2a”) and the speed of the key 2a, a normal musical sound, which is a musical sound normally assigned to the key 2a, and a special musical sound, which is different from the normal musical sound, are independently generated. Referring to FIG. 2A and FIG. 2B, the generation of the normal musical sound and the special musical sound will be described.

FIG. 2A is a graph showing the transition of the position of the key 2a in a case of generating the normal musical sound, and FIG. 2B is a graph showing the transition of the position of the key 2a in a case of generating the special musical sound. In FIG. 2A and FIG. 2B, the vertical axis represents the position of the key 2a (key depression position), and the horizontal axis represents time. Here, in this embodiment, the position of the key 2a is assumed to become smaller (lower) as the key 2a is pushed in.

In this embodiment, a musical sound with the timbre of “violin arco” is set as the normal musical sound, and a musical sound with the timbre of “violin pizzicato” is set as the special musical sound. The settings are not limited to “violin arco” for the normal musical sound and “violin pizzicato” for the special musical sound, and other timbres may be set for the normal musical sound and the special musical sound. In this case, it is preferable to set a timbre based on an attenuated sound that is generated without receiving a note off, such as “violin pizzicato” (another example is “guitar muted sound”), as the special musical sound. By setting such a timbre to the special musical sound, the user H can generate musical sounds such as “violin pizzicato” and “guitar muted sound” without discomfort, with the feeling of plucking a violin or guitar.

In this embodiment, according to the position of the key 2a, a key release position D1, a muting position D2, a determination start position D3, and a sound generation start position Ds are provided. The key release position D1 is a position to which the key 2a returns when moving upward in a case where the user H depresses and then releases the key 2a. The key release position D1 is also a position before the user H touches the key 2a.

The muting position D2 is a position provided lower than the key release position D1. In a case where the key 2a is released and the position of the key 2a becomes equal to or higher than the muting position D2, muting of the normal musical sound or the special musical sound assigned to the key 2a that is being generated starts.

The determination start position D3 is a position provided lower than the muting position D2. In a case where the key 2a is depressed and the position of the key 2a becomes equal to or lower than the determination start position D3, determination of the speed of the key 2a starts. As will be described in detail later, the normal musical sound or the special musical sound is generated according to the determined speed.

The sound generation start position Ds is a position provided lower than the determination start position D3. In a case where the key 2a is depressed, and while the speed of the key 2a is maintained equal to or higher than a speed threshold value Vth, the position of the key 2a becomes equal to or lower than the sound generation start position Ds, the normal musical sound is generated. In this embodiment, “0” is set as the speed threshold value Vth, but the disclosure is not limited thereto. The speed threshold value Vth may be set to 0 or more, or may be set to 0 or less.

First, a case where the normal musical sound is generated will be described with reference to FIG. 2A. In a case where depression of the key 2a starts and the position thereof becomes equal to or lower than the determination start position D3, determination of the speed of the key 2a is started. Specifically, it is determined whether a speed V1 after the position of the key 2a becomes equal to or lower than the determination start position D3 is higher than the speed threshold value Vth.

Then, in a case where the position of the key 2a becomes equal to or lower than the sound generation start position Ds while the speed V1 of the key 2a is maintained higher than the speed threshold value Vth, the normal musical sound of the key 2a is generated. A velocity Vs used when generating the normal musical sound at that time is a speed V2 at the time when the position of the key 2a becomes the sound generation start position Ds. In addition, a pitch corresponding to the depressed key 2a is set as the pitch of the normal musical sound at this time. That is, the user H generates the normal musical sound assigned to the key 2a by pushing the key 2a to a position equal to or lower than the sound generation start position Ds while maintaining the speed equal to or higher than the speed threshold value Vth. While the normal musical sound is generated in this way, the special musical sound assigned to the depressed key 2a is not generated.

Next, a case where the special musical sound is generated will be described with reference to FIG. 2B. Similar to the case of generating the normal musical sound, in a case where depression of the key 2a starts and the position thereof becomes equal to or lower than the determination start position D3, determination of the speed of the key 2a is started. Specifically, it is determined whether a speed V3 after the position of the key 2a becomes equal to or lower than the determination start position D3 is higher than the speed threshold value Vth.

Then, in a case where the speed V4 becomes equal to or lower than the speed threshold value Vth before the position of the key 2a reaches the sound generation start position Ds, the special musical sound of the key 2a is generated. The velocity Vs used when generating the special musical sound at that time is the maximum speed measured from the start of depression of the key 2a until the speed becomes equal to or lower than the speed threshold value Vth. In addition, a pitch corresponding to the depressed key 2a is set as the pitch of the special musical sound at this time. While the special musical sound is generated in this way, the normal musical sound assigned to the depressed key 2a is not generated.

In other words, when the user H pushes the key 2a to a position equal to or lower than the sound generation start position Ds while maintaining the speed equal to or higher than the speed threshold value Vth, the normal musical sound is generated, and the special musical sound is not generated. On the other hand, when the user H pushes the key 2a and stops the key depression operation before the position thereof reaches the sound generation start position Ds, the special musical sound is generated, and the normal musical sound is not generated.

Thus, it is possible to distinguish between a case where only the normal musical sound is generated and a case where the special musical sound is generated according to the position to which the key 2a is pushed and the speed of the key 2a, so two musical sounds, the normal musical sound and the special musical sound, can be independently generated through an operation of the user H on a single key 2a.

For example, in a case of generating a chord of three notes, only one of the three notes is set as a special musical sound and the remaining two notes are set as normal musical sounds, which makes it possible to realize generation of expressive musical sounds that combine the harmony of the chord and the difference between two types of timbres.

The determination of the speed of the key 2a is started in a case where the depressed key 2a becomes equal to or lower than the determination start position D3 that is provided lower than the key release position D1 and the muting position D2. In a case where the position of the key 2a immediately after key depression is in the vicinity of the key release position D1 or the muting position D2, the speed of the key 2a may not fully rise and may be lower than the speed threshold value Vth.

Therefore, the determination of the speed of the key 2a is started in a case where the depressed key 2a becomes equal to or lower than the determination start position D3 that is provided lower than the key release position D1 and the muting position D2, so that it is possible to suppress a situation where the special musical sound is erroneously generated when the speed of the key 2a immediately after key depression does not fully rise, and thereby reduce the discomfort of the user H toward the generation of the special musical sound.

Additionally, the maximum speed measured from the start of depression of the key 2a until the speed becomes equal to or lower than the speed threshold value Vth is used as the velocity Vs when generating the special musical sound. This allows the “momentum” of depressing the key 2a during generation of the special musical sound to be reflected in the velocity Vs, which makes it possible to suppress the discomfort of the user H toward the volume of the special musical sound.

Next, the functions of the synthesizer 1 will be described with reference to FIG. 3. FIG. 3 is a functional block diagram of the synthesizer 1. As shown in FIG. 3, the synthesizer 1 includes a normal musical sound generation part 500 and a special musical sound generation part 501.

The normal musical sound generation part 500 is a part for generating a normal musical sound in a case where the position of the key 2a reaches the sound generation start position Ds after the key 2a is depressed, and is implemented by the CPU 100 to be described later in FIG. 4. The special musical sound generation part 501 is a part for generating a special musical sound different from the normal musical sound in a case where the speed of the key 2a becomes equal to or lower than the speed threshold value Vth before the position of the key 2a reaches the sound generation start position Ds after the key 2a is depressed, and is implemented by the CPU 100.

In other words, in a case where the key 2a is pushed to the sound generation start position Ds, a normal musical sound is generated, and in a case where the speed of the key 2a becomes equal to or lower than the speed threshold value Vth before the key 2a reaches the sound generation start position Ds, a special musical sound is generated. This makes it possible to distinguish between a case where only the normal musical sound is generated according to the position where the key 2a is depressed and the speed of the key 2a, and a case where the special musical sound is generated. Therefore, two musical sounds, the normal musical sound and the special musical sound, can be independently generated through an operation of the user H on a single key 2a.

Next, the electrical configuration of the synthesizer 1 will be described with reference to FIG. 4. FIG. 4 is a block diagram showing the electrical configuration of the synthesizer 1. The synthesizer 1 includes the CPU 100, a flash ROM 101, a RAM 102, the keyboard 2 and setting buttons P described above, a sound source 103, and a DSP (Digital Signal Processor) 104, which are respectively connected via a bus line 105. A DAC (Digital Analog Converter) 106 is connected to the DSP 104, an amplifier 107 is connected to the DAC 106, and a speaker 108 is connected to the amplifier 107.

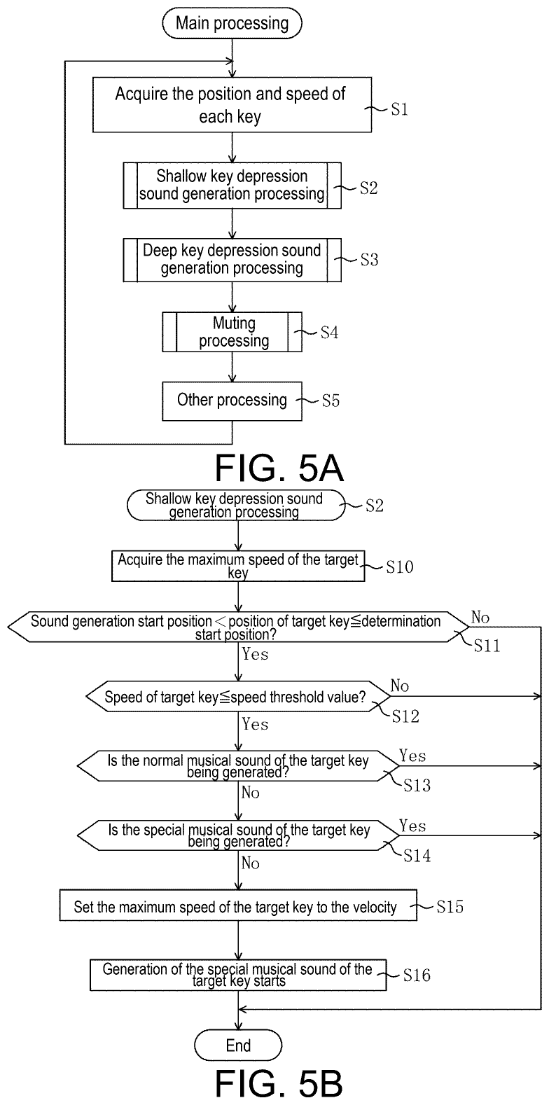

The CPU 100 is a computing device that controls each part connected by the bus line 105. The flash ROM 101 is a rewritable non-volatile memory and has a control program 101a. When the control program 101a is executed by the CPU 100, the main processing of FIG. 5A is executed. The RAM 12 is a memory that rewritably stores various work data, flags, etc. when the CPU 100 executes programs such as the control program 101a.

The sound source 103 is a device that outputs waveform data corresponding to performance information input from the CPU 100. The DSP 104 is a computing device for performing calculation processing on the waveform data input from the sound source 103. The DAC 106 is a conversion device that converts the waveform data input from the DSP 104 into analog waveform data. The amplifier 107 is an amplification device that amplifies the analog waveform data output from the DAC 106 at a predetermined gain. The speaker 108 is an output device that releases (outputs) the analog waveform data amplified by the amplifier 107 as a musical sound.

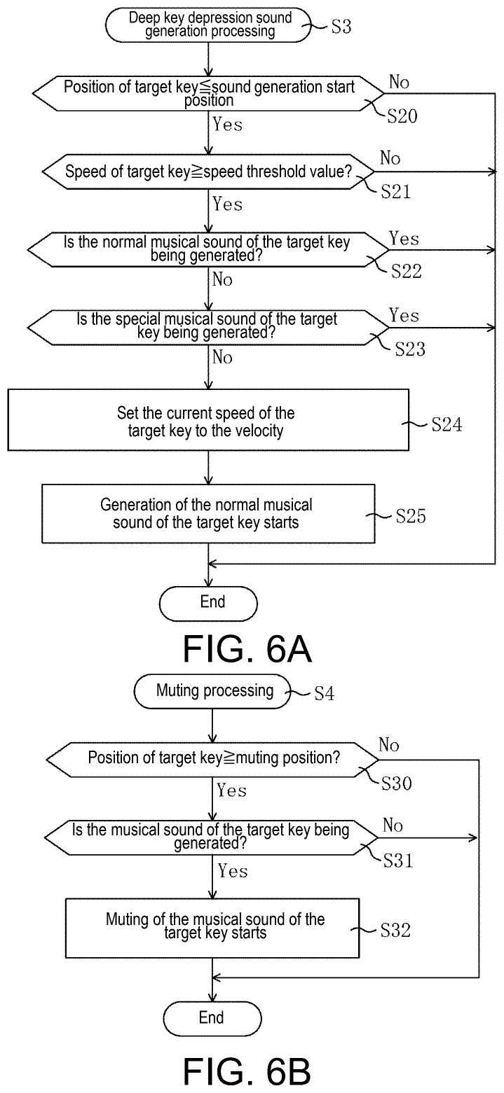

Next, the processing executed by the CPU 100 will be described with reference to FIG. 5A, FIG. 5B, FIG. 6A, and FIG. 6B. FIG. 5A is a flowchart of the main processing. The main processing is processing executed when the synthesizer 1 is powered on. The main processing first acquires the position and speed of each key 2a provided on the keyboard 2 (S1).

After the processing of S1, shallow key depression sound generation processing (S2), deep key depression sound generation processing (S3), and muting processing (S4) are executed in sequence. The processing of S2 to processing of S4 are executed for each key 2a. After the muting processing of S4, other processing (S5) of the synthesizer 1 is executed, and the processing from S1 is repeated. Here, the shallow key depression sound generation processing of S2, the deep key depression sound generation processing of S3, and the muting processing of S4 will be described with reference to FIG. 5B, FIG. 6A, and FIG. 6B.

FIG. 5B is a flowchart of the shallow key depression sound generation processing. The shallow key depression sound generation processing is processing for generating a special musical sound. The shallow key depression sound generation processing first acquires the maximum speed from the start of depression of the target key 2a for the shallow key depression sound generation processing (S10). Hereinafter, the key 2a that is the target of the shallow key depression sound generation processing will be abbreviated as “target key 2a.” The same applies to the deep key depression sound generation processing and the muting processing in FIG. 6A and FIG. 6B.

After the processing of S10, it is confirmed whether the position of the target key 2a is higher than the sound generation start position Ds and equal to or lower than the determination start position D3 (S11). In the processing of S11, in a case where it is confirmed that the position of the target key 2a is higher than the sound generation start position Ds and equal to or lower than the determination start position D3 (S11: Yes), it is confirmed whether the speed of the target key 2a is equal to or lower than the speed threshold value Vth (S12).

In the processing of S12, in a case where it is confirmed that the speed of the target key 2a is equal to or lower than the speed threshold value Vth (S12: Yes), it is confirmed whether the normal musical sound of the target key 2a is being generated (S13). In the processing of S13, in a case where it is confirmed that the normal musical sound of the target key 2a is not being generated (S13: No), it is further confirmed whether the special musical sound of the target key 2a is being generated (S14). In the processing of S14, in a case where it is confirmed that the special musical sound of the target key 2a is not being generated (S14: No), the maximum speed acquired in the processing of S10 is set to the velocity Vs (S15), and the generation of the special musical sound of the target key 2a is started (S16).

On the other hand, in the processing of S13, in a case where it is confirmed that the normal musical sound of the target key 2a is being generated (S13: Yes), the processing of S14 to the processing of S16 are skipped, and in the processing of S14, in a case where it is confirmed that the special musical sound of the target key 2a is being generated (S14: Yes), the processing of S15 and the processing of S16 are skipped, and the generation of the special musical sound of the target key 2a is not started.

In particular, after the target key 2a is depressed, when the position of the key 2a becomes equal to or lower than the sound generation start position Ds while the speed of the key 2a is maintained higher than the speed threshold value Vth, the generation of the normal musical sound of the key 2a is started. Then, even if the key 2a is released, and during that release, the key 2a is depressed again before reaching the muting position D2, and the speed of the key 2a becomes equal to or lower than the speed threshold value Vth before the position of the key 2a reaches the sound generation start position Ds, the generation of the special musical sound of the target key 2a is not started. That is, the generation of the normal musical sound and the generation of the special musical sound are exclusive, and since it is possible to suppress the situation where the normal musical sound and the special musical sound are generated during a series of key depression to key release, the discomfort of the user H toward the generated musical sound can be suppressed.

Further, after the target key 2a is depressed, when the speed of the key 2a becomes equal to or lower than the speed threshold value Vth before the position of the key 2a reaches the sound generation start position Ds, the generation of the special musical sound of the key 2a is started. Then, even if the key 2a is released, and during that release, the key 2a is depressed again before reaching the muting position D2, and the speed of the key 2a becomes equal to or lower than the speed threshold value Vth before the position of the key 2a reaches the sound generation start position Ds, regeneration of the special musical sound is not started. Thus, it is possible to suppress the situation where the special musical sound is generated multiple times during a series of key depression to key release, which can also suppress the discomfort of the user H toward the generated musical sound.

In the processing of S12, in a case where it is confirmed that the speed of the target key 2a is higher than the speed threshold value Vth (S12: No), the processing of S13 to the processing of S16 are skipped. In addition, in the processing of S11, in a case where it is confirmed that the position of the target key 2a is not higher than the sound generation start position Ds and equal to or lower than the determination start position D3 (S11: No), the processing of S12 to the processing of S16 are skipped. After the processing of S11 to the processing of S14 and the processing of S16, the shallow key depression sound generation processing is terminated.

FIG. 6A is a flowchart of the deep key depression sound generation processing. The deep key depression sound generation processing is processing for generating a normal musical sound. The deep key depression sound generation processing first confirms whether the position of the target key 2a is equal to or lower than the sound generation start position Ds (S20). In the processing of S20, in a case where it is confirmed that the position of the target key 2a is equal to or lower than the sound generation start position Ds (S20: Yes), it is confirmed whether the speed of the target key 2a is higher than the speed threshold value Vth (S21).

In the processing of S21, in a case where it is confirmed that the speed of the target key 2a is higher than the speed threshold value Vth (S21: Yes), it is confirmed whether the normal musical sound of the target key 2a is being generated (S22). In the processing of S22, in a case where it is confirmed that the normal musical sound of the target key 2a is not being generated (S22: No), it is further confirmed whether the special musical sound of the target key 2a is being generated (S23). In the processing of S23, in a case where it is confirmed that the special musical sound of the target key 2a is not being generated (S23: No), the current speed of the target key 2a is set to the velocity Vs (S24), and the generation of the normal musical sound of the target key 2a is started (S25).

On the other hand, in the processing of S22, in a case where it is confirmed that the musical sound of the target key 2a is being generated (S22: Yes), the processing of S23 to the processing of S25 are skipped, and in the processing of S23, in a case where it is confirmed that the special musical sound of the target key 2a is being generated (S23: Yes), the processing of S24 and the processing of S25 are skipped, and the generation of the normal musical sound of the target key 2a is not started.

In particular, after the target key 2a is depressed, when the speed of the key 2a becomes equal to or lower than the speed threshold value Vth before the position of the key 2a reaches the sound generation start position Ds, the generation of the special musical sound of the key 2a is started. Then, even if the key 2a is released, and during that release, the key 2a is depressed again before reaching the muting position D2, and the position of the key 2a becomes equal to or lower than the sound generation start position Ds while the speed thereof is maintained higher than the speed threshold value Vth, the normal musical sound of the target key 2a is not generated. That is, the generation of the normal musical sound and the generation of the special musical sound are exclusive, and since it is possible to suppress the situation where the normal musical sound and the special musical sound are generated during a series of key depression to key release, the discomfort of the user H toward the generated musical sound can be suppressed.

Further, after the target key 2a is depressed, when the position of the key 2a becomes equal to or lower than the sound generation start position Ds while the speed of the key 2a is maintained higher than the speed threshold value Vth, the generation of the normal musical sound of the key 2a is started. Then, even if the key 2a is released, and during that release, the key 2a is depressed again before reaching the muting position D2, and the position of the key 2a becomes equal to or lower than the sound generation start position Ds while the speed thereof is maintained higher than the speed threshold value Vth, regeneration of the normal musical sound is not started. Thus, it is possible to suppress the situation where the normal musical sound is generated multiple times during a series of key depression to key release, which can also suppress the discomfort of the user H toward the generated musical sound.

In the processing of S21, in a case where it is confirmed that the speed of the target key 2a is equal to or lower than the speed threshold value Vth (S21: No), the processing of S22 to the processing of S25 are skipped. In addition, in the processing of S20, in a case where it is confirmed that the position of the target key 2a is higher than the sound generation start position Ds (S20: No), the processing of S21 to the processing of S25 are skipped. After the processing of S20 to the processing of S23 and the processing of S25, the deep key depression sound generation processing is terminated.

FIG. 6B is a flowchart of the muting processing. The muting processing is processing for muting the musical sound of the target key 2a that is being generated in a case where the position of the target key 2a becomes equal to or higher than the muting position D2. The muting processing first confirms whether the position of the target key 2a is equal to or higher than the muting position D2 (S30). In the processing of S30, in a case where it is confirmed that the position of the target key 2a is equal to or higher than the muting position D2 (S30: Yes), it is confirmed whether the musical sound of the target key 2a is being generated (S31). Specifically, it is confirmed whether either the normal musical sound or the special musical sound of the target key 2a is being generated.

In the processing of S31, in a case where it is confirmed that the musical sound of the target key 2a is being generated (S31: No), the muting of the musical sound of the target key 2a is started (S32). On the other hand, in the processing of S31, in a case where it is confirmed that the musical sound of the target key 2a is not being generated (S31: No), the processing of S32 is skipped. In addition, in the processing of S30, in a case where it is confirmed that the position of the target key 2a is lower than the muting position D2 (S30: No), the processing of S31 and the processing of S32 are skipped. After the processing of S30 to the processing of S32, the muting processing is terminated.

Although the disclosure has been described based on the above embodiment, it can be easily inferred that various improvements and changes are possible.

In the above embodiment, in a case where the speed of the key 2a becomes equal to or lower than the speed threshold value Vth before the position of the key 2a reaches the sound generation start position Ds, the special musical sound is generated without generating the normal musical sound. However, the disclosure is not limited thereto, and in a case where the acceleration of the key 2a becomes equal to or lower than the acceleration threshold value Ath (for example, 0) before the position of the key 2a reaches the sound generation start position Ds, the special musical sound may be generated without generating the normal musical sound.

In this case, the normal musical sound may be generated in a case where the speed of the key 2a is maintained equal to or higher than the speed threshold value Vth until the position of the key 2a reaches the sound generation start position Ds, or in a case where the acceleration of the key 2a is maintained equal to or higher than the acceleration threshold value Ath until the position of the key 2a reaches the sound generation start position Ds.

In the above embodiment, the configuration is made so that two types of musical sounds, the normal musical sound and the special musical sound, are generated for one key 2a. However, the disclosure is not limited thereto, and the configuration may be made so that three or more types of musical sounds (that is, a normal musical sound and two or more types of special musical sounds) are generated for one key 2a.

For example, a second special musical sound determination position is provided between the determination start position D3 and the sound generation start position Ds in FIG. 2A and FIG. 2B. In a case where the key 2a is depressed and the speed of the key 2a becomes equal to or lower than the speed threshold value Vth between the determination start position D3 and the second special musical sound determination position, a first special musical sound, which is the first type of special musical sound, is generated. In a case where the key 2a is depressed and passes through the second special musical sound determination position while the speed of the key 2a is maintained at the speed threshold value Vth, and the speed of the key 2a becomes equal to or lower than the speed threshold value Vth between the second special musical sound determination position and the sound generation start position Ds, a second special musical sound, which is different from the first special musical sound, is generated.

Further, in a case where the key 2a is depressed and reaches the sound generation start position Ds while the speed of the key 2a is maintained at the speed threshold value Vth, a normal musical sound (however, a musical sound different from each of the first and second special musical sounds) may be generated. In this case, the velocity Vs of the first special musical sound may use the maximum speed of the key 2a measured between the determination start position D3 and the second special musical sound determination position, and the velocity Vs of the second special musical sound may use the maximum speed of the key 2a measured between the determination start position D3 and the sound generation start position Ds.

In the above embodiment, in the processing of S13 to the processing of S16 of the shallow key depression sound generation processing in FIG. 5B, in a case where both the normal musical sound and the special musical sound of the target key 2a are not being generated (S13, S14), the generation of the special musical sound of the target key 2a is started (S15, S16). However, the disclosure is not limited thereto. For example, the processing of S13 or the processing of S14 may be omitted, and the generation of the special musical sound of the target key 2a may be started regardless of the generation state of the normal musical sound and the special musical sound of the target key 2a.

Similarly, in the processing of S22 to the processing of S25 of the deep key depression sound generation processing in FIG. 6A, in a case where both the normal musical sound and the special musical sound of the target key 2a are not being generated (S22, S23), the generation of the normal musical sound of the target key 2a is started (S24, S25). However, the disclosure is not limited thereto. For example, the processing of S22 or the processing of S23 may be omitted, and the generation of the normal musical sound of the target key 2a may be started regardless of the generation state of the normal musical sound and the special musical sound of the target key 2a.

In the above embodiment, the normal musical sound and the special musical sound were made into different musical sounds by using different timbres. However, the disclosure is not limited thereto. The normal musical sound and the special musical sound may be made into different musical sounds by respectively applying different acoustic effects for the normal musical sound and the special musical sound (for example, setting delay for the normal musical sound and reverb for the special musical sound).

Alternatively, the normal musical sound and the special musical sound may be made into different musical sounds by making the respective timbre parameters different, which are parameters of setting items representing aspects of timbre such as attack, decay, sustain or release, and cutoff frequency applied to the normal musical sound and the special musical sound. For example, regarding release that represents the reverberation of the musical sound, the release of the special musical sound may be set faster than the normal musical sound. In addition, the cutoff frequency of the special musical sound may be set lower than the normal musical sound.

In the above embodiment, the determination start position D3 is set lower than the muting position D2. However, the disclosure is not limited thereto. The determination start position D3 may be set at the same position as the muting position D2, or may be set higher than the muting position D2.

In the above embodiment, the maximum speed from the start of depression of the key 2a until the speed becomes equal to or lower than the speed threshold value Vth is used as the velocity Vs of the special musical sound. However, the disclosure is not limited thereto. For example, as the velocity Vs, other values related to the speed of the key 2a such as the average value or the mode value of the speed from the start of depression of the key 2a until the speed becomes equal to or lower than the speed threshold value Vth may be used, or a fixed value may be set regardless of the speed of the key 2a.

In addition, the speed V2 at the time when the position of the key 2a becomes the sound generation start position Ds is used as the velocity Vs of the normal musical sound. However, the disclosure is not limited thereto. For example, similar to the velocity Vs of the special musical sound, the maximum speed from the start of depression of the key 2a until the position of the key 2a becomes the sound generation start position Ds may be used, or other values related to the speed of the key 2a such as the average value or the mode value of the speed from the start of depression of the key 2a until the position of the key 2a becomes the sound generation start position Ds may be used, or a fixed value may be set regardless of the speed of the key 2a.

In the above embodiment, the control program 101a is stored in the flash ROM 101 of the synthesizer 1 and configured to operate on the synthesizer 1. However, the disclosure is not necessarily limited thereto, and the control program 101a may be configured to operate on other computers such as PC (personal computer), mobile phone, smartphone or tablet terminal, etc. In this case, a keyboard device with a configuration similar to the keyboard 2 may be connected to the PC, mobile phone, etc.

What is claimed is:

1. An electronic musical instrument, comprising a keyboard having a plurality of keys, the electronic musical instrument comprising:
a hardware processor configured to:
generate a normal musical sound in a case where, after the key is depressed, a position of the key reaches a sound generation start position; and
generate a special musical sound different from the normal musical sound in a case where, after the key is depressed, a speed of the key becomes equal to or lower than a speed threshold value or an acceleration of the key becomes equal to or lower than an acceleration threshold value before the position of the key reaches the sound generation start position.

2. The electronic musical instrument according to claim 1, wherein the hardware processor calculates a velocity when generating the special musical sound based on a maximum speed of the key until the speed of the key becomes equal to or lower than the speed threshold value after the key is depressed.

3. The electronic musical instrument according to claim 1, wherein a determination start position is provided at a position lower than a release position of the key and higher than the sound generation start position, and
the hardware processor generates the special musical sound in a case where, after the key is depressed, the position of the key is equal to or lower than the determination start position, and the speed of the key becomes equal to or lower than the speed threshold value before the position of the key reaches the sound generation start position.

4. The electronic musical instrument according to claim 1, wherein the hardware processor prevents from performing generation of the normal musical sound in a case where, after generation of the special musical sound, the key is further depressed and the position of the key reaches the sound generation start position.

5. The electronic musical instrument according to claim 1, wherein the hardware processor prevents from performing generation of the special musical sound in a case where, after generation of the normal musical sound, the key is depressed again during release of the key, and the speed of the key becomes equal to or lower than the speed threshold value before the position of the key reaches the sound generation start position.

6. The electronic musical instrument according to claim 1, wherein the normal musical sound and the special musical sound have different timbres.

7. The electronic musical instrument according to claim 6, wherein the special musical sound is a timbre based on an attenuated sound that is generated without receiving a note off.

8. The electronic musical instrument according to claim 1, wherein the normal musical sound and the special musical sound have different timbre parameters.

9. The electronic musical instrument according to claim 8, wherein the timbre parameters are each a release that expresses reverberation of a musical sound.

10. A musical sound output method executed in an electronic musical instrument comprising a keyboard having a plurality of keys, the musical sound output method comprising:
generating a normal musical sound in a case where, after the key is depressed, a position of the key reaches a sound generation start position; and
generating a special musical sound different from the normal musical sound in a case where, after the key is depressed, a speed of the key becomes equal to or lower than a speed threshold value or an acceleration of the key becomes equal to or lower than an acceleration threshold value before the position of the key reaches the sound generation start position.

11. A non-transitory computer readable recording medium storing a musical sound output program for causing a computer comprising a keyboard having a plurality of keys to execute musical sound output processing, the musical sound output program causing the computer to execute:
generating a normal musical sound in a case where, after the key is depressed, a position of the key reaches a sound generation start position; and
generating a special musical sound different from the normal musical sound in a case where, after the key is depressed, a speed of the key becomes equal to or lower than a speed threshold value or an acceleration of the key becomes equal to or lower than an acceleration threshold value before the position of the key reaches the sound generation start position.
